(19) United States
(12) Patent Application Publication
(10) Pub. No.: US 2001/0035425 A1
(43) Pub. Date: Nov. 1, 2001

(54) Method of selling cellular telephones and other handheld electronic communications devices through use of vending machines

(76) Inventors: Mark Rocco, Berlin, NJ (US); Allan Sanford, Wurtsboro, NY (US)

Correspondence Address: MARK ROCCO, 11 VILLA DRIVE, BERLIN, NJ, 08009, US

(21) Appl. No.: 09/769,175

(22) Filed: Jan. 25, 2001

Related U.S. Application Data
(60) Provisional application No. 60/203,230, filed on May 8, 2000.

(51) Int. Cl. G07F 11/00

(52) U.S. Cl. 221/2

(57) ABSTRACT

A vending machine, within which are placed a number of handheld electronic communications devices, such as but not limited to cellular telephones, pages and similar devices which may be invented in the future, said machines being placed in various locations and available to the general public, who will, upon paying a predetermined amount of legal tender or use of personal credit (cards), be delivered of the handheld electronic communication device by the vending machine, independently of any human intervention.

This application relates to a Provisional Patent Application Number 60/203,230, filing date May 8, 2000.

### FIELD OF INVENTION

This invention relates to the selling of cellular telephones and other hand held electronic devices used for the purpose of communication between people.

### BACKGROUND

To date, cellular telephones and other electronic devices used for interpersonal communication have been sold through retail stores and through the companies that are offering the devices as well as the airtime (amount of time a user may effectively use the device) sold to the user of the device. Our invention provides a unique selling method by installing the electronic communication devices in a vending machine, with each electronic communication device having been or will be programmed after purchase with a certain number of airtime minutes of use. The vending machine is then placed in various locations, accessible to potential buyers. For purposes of this application, a vending machine may be defined as a mechanical device that, without human intervention, and upon payment of a predetermined amount of money or use of a purchasers credit card into the machine, dispenses a hand held electronic communications device.

Payment for the device will be either cash (legal tender of that country) or by use of a credit card.

Present selling methods require the purchaser of the communication device to enter into a contract with the provider of the airtime minutes, or to contractually agree to purchase a specified number of airtime minutes through the service provider. This process involves the selection of one particular plan, out of many, that the service provider offers to a potential user of their service, and is complicated and of long-term duration. Our system of selling is simple and direct, and accessible to many potential buyers who, among other objections, normally would not buy an electronic communication device because of the complexity of the process as well as the long-term duration of the commitment.

### OBJECTS AND ADVANTAGES

Our invention provides the opportunity to potential buyers of hand held electronic communication devices to conveniently and quickly purchase our devices from vending machines which are located in various retail outlets, as well as hotels, motels, airports, bus depots, car rental agencies, highway rest stops and any other similar locations. The ease of purchase and limited commitment for long-term involvement with the company selling the electronic communication devices, as well as the airtime minutes, will appeal to a segment of the buying public that till now has avoided purchasing these types of devices.

In addition, buying from our vending machines will appeal to a traveler who wants the convenience of being able to stay in communication with others while traveling, but who either has not to the present bought this type of device or who has only one device which is being used by another person and is unavailable for his or her own use.

Others finding our vending machine method of selling appealing are people on limited budgets who buy the device through our machine at a fixed price for the device including airtime minutes, with no further commitment for future airtime minute purchase.

Other people who will find our vending machine selling method appealing are those people whose poor credit rating precludes their contractual involvement with the device/airtime provider.

### SUMMARY, RAMIFICATIONS, and SCOPE

Accordingly, it is obvious that placing a number of hand held, electronic interpersonal communications devices into vending machines which will dispense them to a buyer, with the device preprogrammed or programmed after purchase with a number of airtime minutes of use, creates a unique new selling venue for these devices. Our vending machines will provide inexpensive and convenient access to random purchasers of these types of devices.

Our vending machines will allow purchasers of the devices to buy the devices from our vending machines without entering into a contract with the airtime provider.

Our vending machines will allow purchasers of the devices to buy the device from our machines without undergoing a credit check, which is a usual requirement prior to entering into a legally binding contract with the device and/or airtime provider.

Although the description above contains many specificities, these should not be construed as limiting the scope of the invention but as merely providing illustrations of some of the presently preferred embodiments of this invention. For example, future developments in technology may produce hand held electronic communications devices that we cannot foresee at this time, but would be sold through our vending machine method.

Thus the scope of the invention should be determined by the appended claims and their legal equivalents, rather than by the examples given.

1. Our invention is a combination of a machine, commonly called a vending machine, capable of accepting either legal tender (cash) or credit card payment that will, upon payment, and independently of human intervention, dispense an electronic handheld communication device to a purchaser.
